(19) United States
(12) Patent Application Publication
(10) Pub. No.: US 2023/0074754 A1
(43) Pub. Date: Mar. 9, 2023

(54) Automotive Side Mirror Wiper

(71) Applicant: Jermaine Hamm, Cleveland, OH (US)

(72) Inventor: Jermaine Hamm, Cleveland, OH (US)

(21) Appl. No.: 17/469,918

(22) Filed: Sep. 9, 2021

(51) Int. Cl. B60R 1/06; A46B 13/02; A46B 9/00

(52) U.S. Cl. CPC B60R 1/0602; A46B 13/02; A46B 9/005; A46B 2200/3046

(57) ABSTRACT

An article of manufacture for providing vehicle automatic wipers for side mirrors is disclosed. The automatic wipers includes a larger support structure coupled to an outside structure of the vehicle side mirrors on each side of the vehicle, a wiper arm coupled to the larger support structure being configured to orient the wiper arm in front of the vehicle side mirror, a wiper device coupled to the wiper arm being positioned to remain in contact with the side mirror of the vehicle when the wiper arm is in motion, a motor coupled within the larger support structure and being coupled to the wiper arm while being configured to move the wiper arm across the side mirror of the vehicle, and a control device communicatively coupled to the motor having a plurality of settings that activate and control the speed of the motor.

### TECHNICAL FIELD

This application relates in general to an article of manufacture for providing automotive vehicle safety devices, and more specifically, to an article of manufacture providing automatic wipers for side mirrors.

### BACKGROUND

According to vehicle registration statistics, more than 284 million vehicles are registered in the United States. More than 6 million new vehicles are sold each year. Each of these vehicle's owners have experienced bad weather with rain, snow, and ice. Millions of drivers struggle to clear their side mirrors of dust, dirt, rain, snow, and ice for better visibility and safety while the vehicle is in motion. Keeping side mirrors clean and clear in sudden weather changes helps drivers to avoid accidents.

Therefore, a need exists for an article of manufacture that provides automatic wipers for vehicle side mirrors. The present invention attempts to address the limitations and deficiencies in prior solutions according to the principles and example embodiments disclosed herein.

### SUMMARY

In accordance with the present invention, the above and other problems are solved by providing an article of manufacture for automotive vehicle safety devices, and more specifically, an article of manufacture providing automatic wipers for side mirrors according to the principles and example embodiments disclosed herein.

In one embodiment, the present invention is an article of manufacture for providing automatic wipers for side mirrors. The automatic wipers includes a larger support structure coupled to an outside structure of the vehicle side mirrors on each side of the vehicle, a wiper arm coupled to the larger support structure being configured to orient the wiper arm in front of the vehicle side mirror, a wiper device coupled to the wiper arm being positioned to remain in contact with the side mirror of the vehicle when the wiper arm is in motion, a motor coupled within the larger support structure and being coupled to the wiper arm while being configured to move the wiper arm across the side mirror of the vehicle, and a control device communicatively coupled to the motor having a plurality of settings that activate and control the speed of the motor.

In another aspect of the present invention, the control device comprises a rotating dial having a plurality of positions corresponding to a speed of operation of the motor.

In another aspect of the present invention, the plurality of positions of the rotating dial comprises off, slow speed, medium speed, and fast speed.

In another aspect of the present invention, the plurality of positions of the rotating dial each transmit a speed signal to the motor corresponding to the position on the rotating dial.

In another aspect of the present invention, the speed signal is transmitted over an electrical wire routed from the control device to the motor.

In another aspect of the present invention, the speed signal is transmitted over a wireless connection from the control device to the motor.

In another aspect of the present invention, the wireless connection comprises a Bluetooth™ channel, infrared signal, an RF signal, and a WiFi signal.

In another aspect of the present invention, the control device comprises a mobile application on a smartphone.

In another aspect of the present invention, the wiper device comprises a wiper blade.

In another aspect of the present invention, the wiper device comprises a wiper brush.

In another aspect of the present invention, the larger support structure comprises a wiper device having a vertical rod having a motor housing containing the motor attached to a center.

In another aspect of the present invention, the vertical rod comprises a pair of attachment devices coupled to each end of the vertical rod.

In another aspect of the present invention, the attachment devices couple to external poles supporting the side mirror.

In another aspect of the present invention, the attachment devices couple to housing containing the side mirror.

In another aspect of the present invention, the vehicle is a truck.

In another aspect of the present invention, the vehicle is an automobile.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-d illustrate an example truck side mirror using an article of manufacture for providing vehicle automatic wipers for side mirrors according to the present invention.

FIGS. 2a-e illustrates an outside view of an example truck side mirror using an article of manufacture for providing vehicle automatic wipers for side mirrors according to the present invention.

FIGS. 3a-c illustrate a set of components within an article of manufacture for providing truck side mirror automatic wipers for side mirrors according to the present invention.

FIGS. 4a-c illustrate views of an article of manufacture for providing truck automatic wipers for side mirrors with a wiper blade according to the present invention.

FIGS. 5a-b illustrate views of a wiper brush for an article of manufacture providing truck automatic wipers for side mirrors according to the present invention.

FIGS. 6a-b illustrate an electric motor within an article of manufacture for providing vehicle automatic wipers for side mirrors according to the present invention.

FIG. 7a-b illustrate an example car side mirror using an article of manufacture for providing vehicle automatic wipers for side mirrors according to the present invention.

FIG. 8 illustrates an example wiper blade device on a car side mirror using an article of manufacture for providing vehicle automatic wipers for side mirrors according to the present invention.

FIGS. 9a-b illustrate front and side views of an example wiper blade device on a car side mirror using an article of manufacture for providing vehicle automatic wipers for side mirrors according to the present invention.

FIGS. 10a-b illustrate a set of components within an article of manufacture for providing car side mirror automatic wipers for side mirrors according to the present invention.

FIGS. 11a-b illustrate views of a wiper brush for an article of manufacture providing vehicle automatic wipers for side mirrors according to the present invention.

### DETAILED DESCRIPTION

This application relates in general to an article of manufacture for providing automotive vehicle safety device, and more specifically, to an article of manufacture for providing vehicle automatic wipers for multiple side mirrors according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The term “invention” or “present invention” refers to the invention being applied for via the patent application with the title “Automotive Side Mirror Wipers.” Invention may be used interchangeably with wipers.

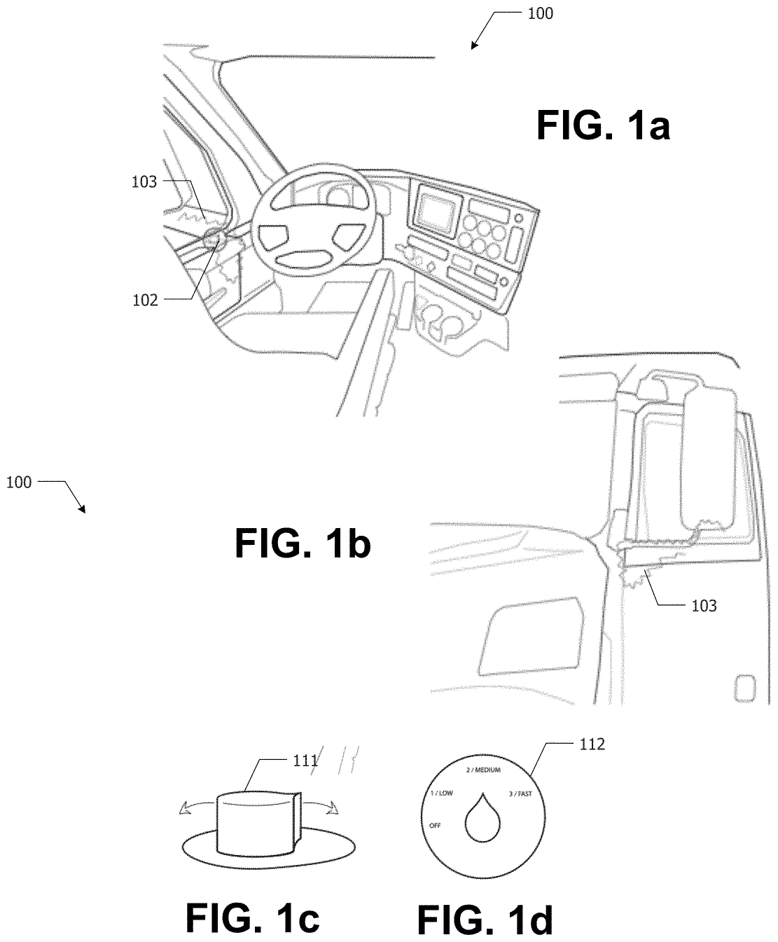

In general, the present disclosure relates to an article of manufacture for providing automotive vehicle safety devices. To better understand the present invention, FIGS. 1a-d illustrate an example truck side mirror using an article of manufacture for providing vehicle automatic wipers for side mirrors according to the present invention. FIG. 1a shows an inside view of a truck having installed a truck automatic wipers for side mirrors according to the present invention. FIG. 1b shows an outside view of a truck having installed a truck automatic wipers for side mirrors according to the present invention.

A side mirror 201 is required to be attached to each side of a truck in some form. The truck side mirror 201 is attached to a mirror housing 105 including a neck or post to attach to a truck. In order to keep the vehicle side mirror 104 clear for use, a wiper is stowed outside the central part of the side mirror 201. The wiper also travels across a significant portion of the side mirror 201 in order to clear enough of the surface of the mirror. These side mirror 201 are found on both front doors of a larger vehicles such as trucks and buses being attached the side mirror 201 to the vehicle itself using a larger support structure 202.

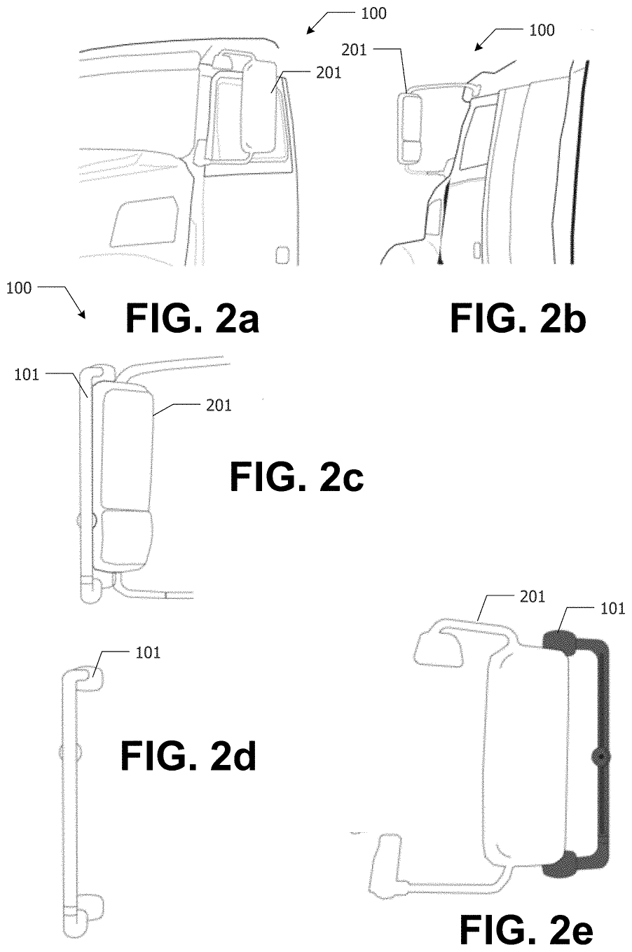

An external wiper system 100 is added both inside the truck cab as on the side mirror 201. A control device 102 installed to the inside door frame or arm rest 101 the having a connecting electrical cable 103 coupling the control device 102 to a truck wiper device 101 attached to the side mirror 201 to the vehicle itself using a larger support structure 202 as shown in FIGS. 2c-e. FIG. 2a-b show front and rear view of the side mirror 201 to the vehicle itself using a larger support structure 202. FIGS. 2c-e shown the truck wiper device 101 and views of the truck wiper device 101 being attached to the truck side mirrors 201.

The connecting electrical cable 103 contains sufficient wiring to share electrical power, ground, and one or more control signals between the control device 102 and the truck wiper device 101. The one or more control signals are generated by the control device 102 shown in FIGS. 1c-d. The control device 102 has a rotating dial 111 having two or more setting positions 112 that generate the one or more control signals used to control the operation of the truck wiper device 101. The setting positions 112 of the control device 102 shown in FIG. 2d comprises four setting positions corresponding to various operating speeds of the truck wiper device 101. The various operating speeds comprise an off position, a slow position, a medium position, and a fast position. When the rotating dial 111 is set to each of these positions, a corresponding command signal is transmitted to the truck wiper device 101 to set its operating speed. The one or more control signals may consist of a signal wire for each speed on the control device 102 in which only one of these signal wires are active while the remaining signal wires are inactive. In another embodiment, a single control wire may be used in which the control signals are set by generating different voltage levels corresponding to each of the operating speeds set by the control device 102 being in each of the different setting positions. In a third embodiment, two control wires may be used with the active and inactive state of these control wires encodes for digital signal values 00, 01, 10, 11 and where each of the digital signal values correspond to a speed setting. Finally, in a last embodiment, the control signals may be wireless transmitted to the truck wiper device 101 using IR, RF, and related electronic signals that may transmit the setting for the operating speed of the wiper. The number of setting positions 112 on the control device 102 may include more or less than the 4 settings shown herein should the truck wiper device 101 operate using a different number of operating modes.

In alternate embodiments, the control device 102 may comprise a mobile application on a smartphone (not shown). The smartphone may communicate with the wiper device 101 wirelessly using NFC, Bluetooth™, and Wifi data connections. The user may rotate the setting of the control device 102 using a touchscreen of the smartphone in a similar manner described herein with a rotating dial.

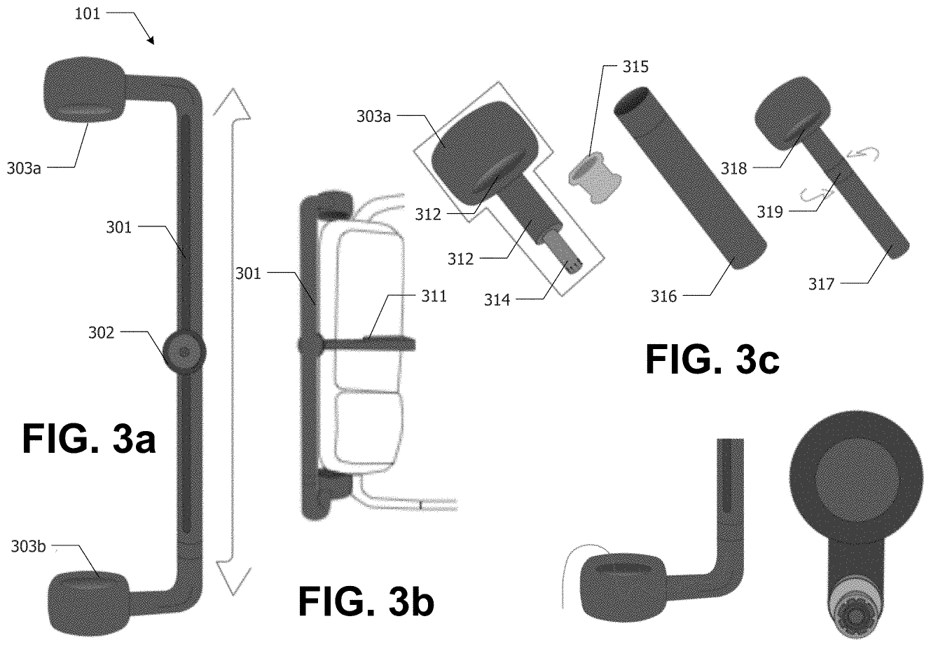

FIGS. 3a-c illustrate a set of components within an article of manufacture for providing truck side mirror automatic wipers for side mirrors according to the present invention. FIG. 3a shows a truck wiper device 101 having a vertical rod 301 having a motor housing 302 attached to its center. Each end of the vertical rod 301 has attachment devices 303a-b for attaching to the side mirror 201 of the truck. Each end of the vertical rod will attach first to the vehicle like a simple screw. Each end of the rod has a small opening that will allow the external pole of the truck mirror to fit in and snap on, then with a small screw to tighten the rod on each side.

FIG. 2b shows the attachment devices 303a-b coupling the truck wiper device 101 to the outside mirror 201 of the truck. One of the truck wiper devices may be located on each side of the truck while connecting to a single control device 102. FIG. 2c shows the components used to create the truck wiper device 101 when assembled. For FIG. 303a-b, the coupling of the truck wiper device 101 to the outside mirror 201 of the truck, and one of the wiper devices may be located on each side of the truck while connecting to one control device with two control panels knob. In a preferred embodiment, this device built in with the vehicle to have a permanent attachment.

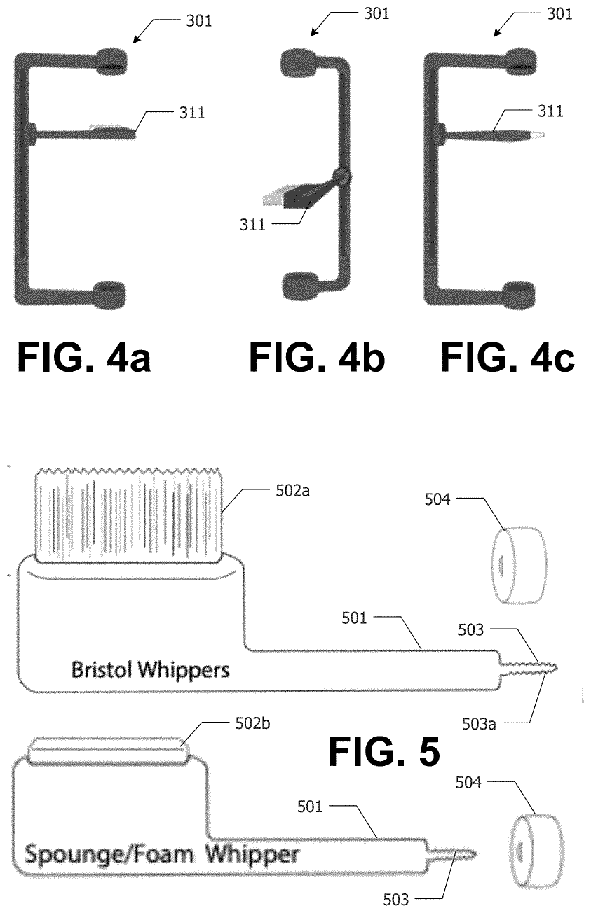

FIGS. 4a-c illustrate views of an article of manufacture for providing vehicle automatic wipers for side mirrors with a wiper blade according to the present invention. FIGS. 4a-c shows 3 views are the wiper blade adjustment options, where the blade can adjust according to the length of the mirror. FIG. 4b shows the wiper blade in just a center state, but in order to remove or change the blade, and the arm can be changed simply rotating the arm in a counterclockwise direction. The blade moves up and down also can be positioned at different heights for operation. In the rest state it will be positioned down and out of view.

FIGS. 5a-b illustrate views of a wiper brush for an article of manufacture providing truck automatic wipers for side mirrors according to the present invention. Different types of wipers may be used to clear and clean the truck side mirrors 102. FIG. 5a shows a wiper brush 502a and FIG. 5b shows a wiper sponge 502b. The wiper brush 502a and the wiper sponge 502b are the component that comes into contact with the surface of the truck side mirror 201 to clear off and clean the surface to allow the mirror to be used. The wiper brush 502a the wiper sponge 502b are attached to a wiper arm 501 having an arm driving connector 503 that is coupled to a motor that causes the wiper arm 501 to move. The arm driving connector 503 passes through a sealing stopper 504 as it is inserted into the motor housing 302 to operate. The bumps along the length of the arm driving connector 503 engage a mating gear or other device inside the motor housing where the motor rotates the gear which causes the arm to sweep the mirror. Arm driving connector 503 has bumps along its length. The bumps are connected to arm driving connector 503 allowing wiper arm 501 to move up and down while also allowing to change or remove. Of course, additional types of wiper devices including wiper blades may be used to clean the truck side mirror.

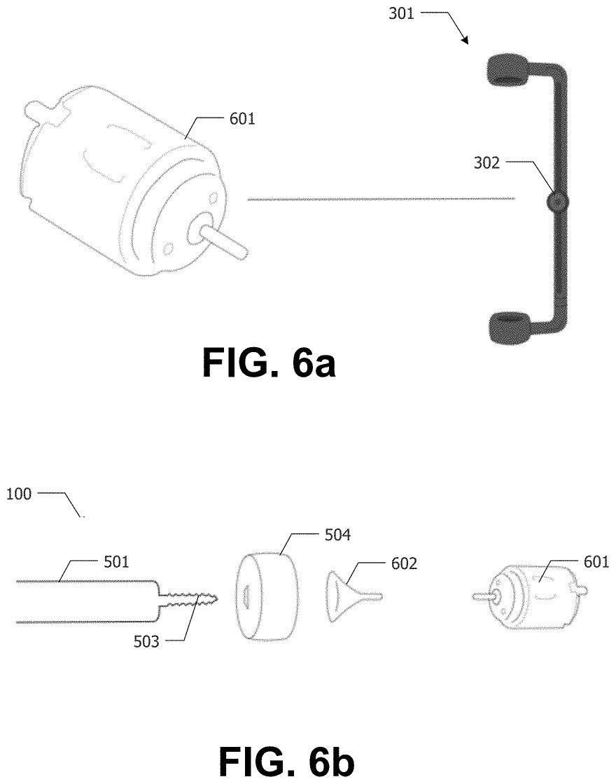

FIGS. 6a-b illustrate an electric motor within an article of manufacture for providing vehicle automatic wipers for side mirrors according to the present invention. FIG. 6a shows an electric motor 601 being utilized within the mirror housing of the truck wiper device 101. FIG. 6b shows the arm driving connector 503 passing through the sealing stopper 504 to engage the washer 602 that connects to the shaft of the motor 601. FIG. 6a-b sealing stopper 504 to engage to washer 602 which is a between sealing stopper 504 and 601 motor. The motor 601 rotates in two directions to move wipers vertically.

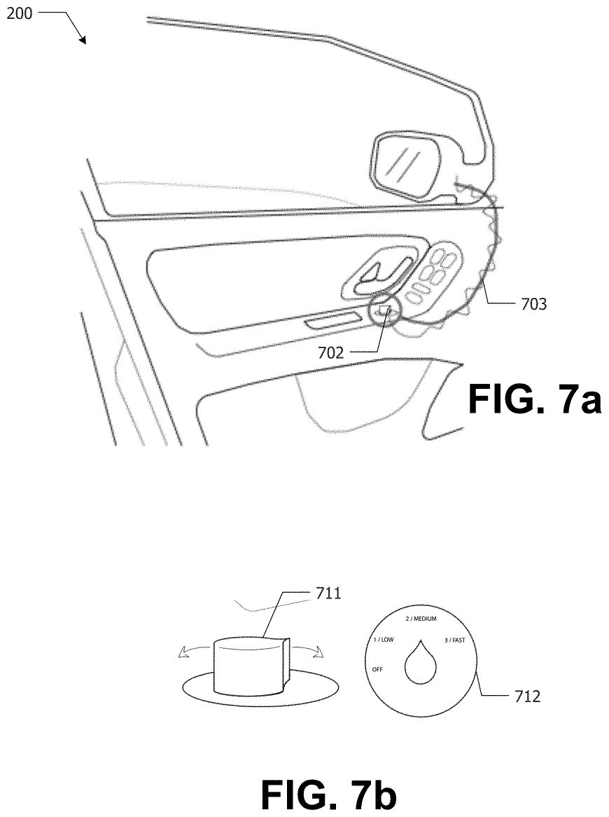

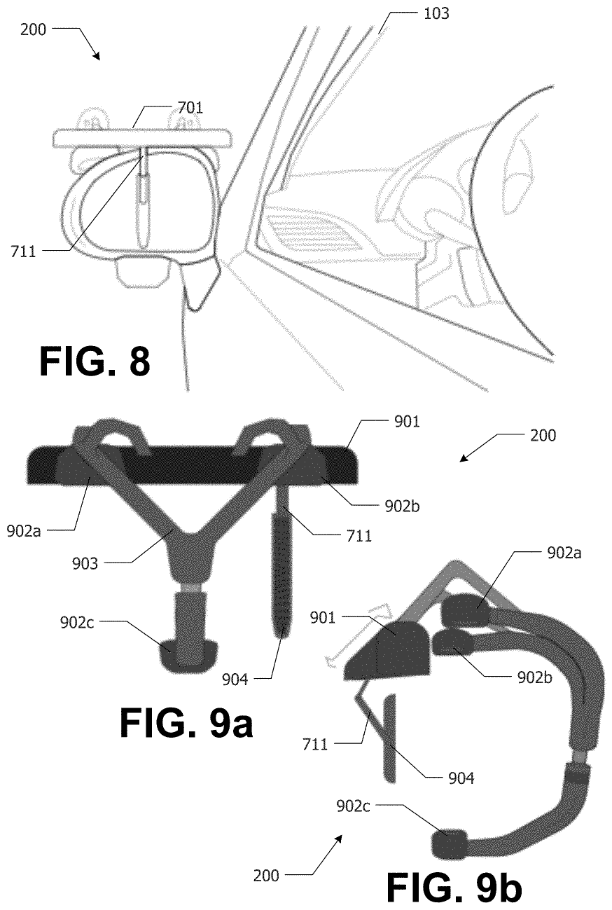

FIG. 7a-b illustrate an example car side mirror using an article of manufacture for providing vehicle automatic wipers for side mirrors according to the present invention. FIGS. 7a-b illustrate an example automobile side mirror 705 using an article of manufacture for providing vehicle automatic wipers for side mirrors according to the present invention. FIG. 7a shows an inside view of an automobile having installed a car automatic wipers 200 for side mirrors according to the present invention. FIG. 8 shows an outside view of an automobile having installed a car automatic wipers 200 for side mirrors 705 according to the present invention.

A side mirror 705 is required to be attached to each side of a car in some form. The car side mirror 705 is attached to a car door including mirror housing 706. In order to keep the car side mirror 705 clear for use, a car wiper device 701 is attached outside the central part of the side mirror housing 706. The wiper arm 711 travels across a significant portion of the side mirror 705 in order to clear enough of the surface of the mirror 705.

The automobile wiper system 200 is added both inside the car as well as on the side mirror 701. A car control device 702 installed to the inside car door frame or arm rest 704 the having a car connecting electrical cable 703 coupling the car control device 702 to a car wiper device 701 attached to the side mirror 705. FIG. 9a-b show front and rear view of the car wiper device 701.

The car connecting electrical cable 703 contains sufficient wiring to share electrical power, ground, and one or more control signals between the car control device 702 and the car wiper device 701. The one or more control signals are generated by the control device 702 in the manner described above with respect to FIGS. 1c-d. The car control device 702 has a car rotating dial 711 having two or more car setting positions 712 that generate the one or more control signals used to control the operation of the car wiper device 701. The car control device 702 is similar to and operates in a manner similar to the control device 102 disclosed herein for use with a truck wiper device 101.

FIGS. 9a-b illustrate front and side views of an example wiper blade device on a car side mirror using an article of manufacture for providing vehicle automatic wipers for side mirrors according to the present invention. The car wiper device 701 comprises a wiper arm support and motor housing 901, a set of car attachment devices 902a-c in which a pair of top car attachment devices 902a-b are coupled to the top of the car side mirror housing 706 and a bottom car attachment device 902c is coupled to the bottom of the car side mirror housing 706. An adjustable connecting arm 903 coupled the car attachment devices 902s-c together to support the wiper arm support and motor housing 901 above and in front of the car side mirror 701. The wiper arm 711 is coupled to the wiper arm support and motor housing 901 and positioned between the car attachment devices 902s-c to be positioned over the car side mirror 701.

FIG. 9 a-b FIG. 902 a, 902 b, is attached to 901 bar which can be tighten to car side to mirror bar 901 also will be able to attach wiper 711 to the bar 901 giving wiper 711 the ability to adjust horizontal allowing the wiper to move horizontal to a vertical direction. In the rest state the wiper will rest on FIG. 901 bar. 902 c will be attached to the bottom of the side mirror with the ability to tighten. 903 is a split are at the top allowing 902a, 902b to tighten to mirror and connect to 902 c allowing that connection to tighten to bottom mirror.

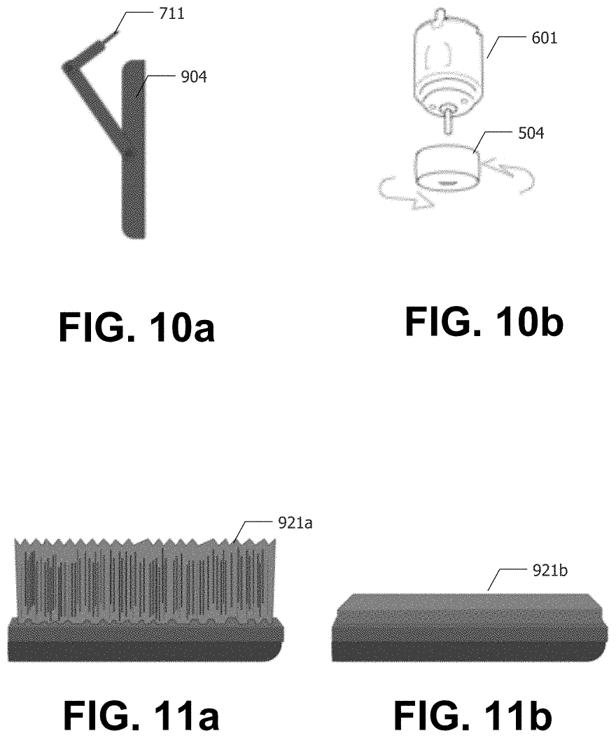

FIGS. 10a-b illustrate a set of components within an article of manufacture for providing car side mirror automatic wipers for side mirrors according to the present invention. FIG. 10a shows wiper 711 attaches to FIG. 901 and gives the wiper the ability to adjust horizontally allowing the wiper to move horizontally to a vertical direction. In the rest state the wiper will rest on bar 901 as shown in FIG. 9 above. Wiper 904 attaches to wiper 711 giving arm 904 the ability to move in a horizontal direction clearing any particles that's on the side mirror. Also wiper 904 holds the bristles/brush to clear the mirror. Motor 601 is the same as the truck version, a small motor that gives sealing stopper 504 power the rotation which then moves wiper 711 in a horizontal direction.

FIGS. 11a-b illustrate views of a wiper brush for an article of manufacture providing vehicle automatic wipers for side mirrors according to the present invention. FIG. 11a shows a brush-like wiper material 921a that may be used for wiper blades 711. FIG. 11b shows a sponge-like wiper material 921b that may be used for wiper blades 711. This material 921b may provide better clearing ability in some circumstances as compared to the wiper brush 921a. As noted above with respect to FIGS. 5a-b, additional types of wiper devices including wiper blades may be used to clean the car side mirror 705.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing vehicle automatic wipers for side mirrors of a vehicle, the automatic wipers comprises:
a larger support structure coupled to an outside structure of the vehicle side mirrors on each side of the vehicle;
a wiper arm coupled to the larger support structure being configured to orient the wiper arm in front of the vehicle side mirror;
a wiper device coupled to the wiper arm being positioned to remain in contact with the side mirror of the vehicle when the wiper arm is in motion;
a motor coupled within the larger support structure and being coupled to the wiper arm while being configured to move the wiper arm across the side mirror of the vehicle;
a control device communicatively coupled to the motor having a plurality of settings that activate and control the speed of the motor.

2. The automatic wipers according to claim 1, wherein the control device comprises a rotating dial having a plurality of positions corresponding to a speed of operation of the motor.

3. The automatic wipers according to claim 2, wherein the plurality of positions of the rotating dial comprises off, slow speed, medium speed, and fast speed.

4. The automatic wipers according to claim 3, wherein the plurality of positions of the rotating dial each transmit a speed signal to the motor corresponding to the position on the rotating dial.

5. The automatic wipers according to claim 4, wherein the speed signal is transmitted over an electrical wire routed from the control device to the motor.

6. The automatic wipers according to claim 4, wherein the speed signal is transmitted over a wireless connection from the control device to the motor.

7. The automatic wipers according to claim 6, wherein the wireless connection comprises a Bluetooth™ channel, infrared signal, an RF signal, and a WiFi signal.

8. The automatic wipers according to claim 6, the control device comprises a mobile application on a smartphone.

9. The automatic wipers according to claim 1, wherein the wiper device comprises a wiper blade.

10. The automatic wipers according to claim 1, wherein the wiper device comprises a wiper brush.

11. The automatic wipers according to claim 1, wherein the wiper device comprises a wiper sponge.

12. The automatic wipers according to claim 1, wherein the larger support structure comprises a wiper device having a vertical rod having a motor housing containing the motor attached to a center.

13. The automatic wipers according to claim 12, wherein the vertical rod comprises a pair of attachment devices coupled to each end of the vertical rod.

14. The automatic wipers according to claim 13, wherein the attachment devices couple to external poles supporting the side mirror.

15. The automatic wipers according to claim 13, wherein the attachment devices couple to housing containing the side mirror.

16. The automatic wipers according to claim 15, wherein the vehicle is a truck.

17. The automatic wipers according to claim 15, wherein the vehicle is an automobile.
